(19) United States
(12) Patent Application Publication
(10) Pub. No.: US 2007/0036920 A1
(43) Pub. Date: Feb. 15, 2007

(54) Pumpkin decorating device

(75) Inventors: Timothy A. Birkmann, Corona, CA (US); Joseph F. Conte, Lake Forest, CA (US); Thomas Charles Weiss, Lake Forest, CA (US)

Correspondence Address: STETINA BRUNDA GARRED & BRUCKER, 75 ENTERPRISE, SUITE 250, ALISO VIEJO, CA, 92656, US

(73) Assignee: Timothy A. Birkmann dba Sunrise Innovations

(21) Appl. No.: 11/204,246

(22) Filed: Aug. 15, 2005

(51) Int. Cl. G09F 17/00; B44C 5/00; A47G 35/00

(52) U.S. Cl. 428/7; 428/28; 428/542.2; 446/101

(57) ABSTRACT

Provided is an insertable pumpkin decoration device for a pumpkin and which is configured to simulate the appearance of traditionally carved Jack O'Lanterns. The pumpkin decoration device comprises facial feature simulation elements that simulate facial features including eyes, a nose, and a mouth, and which are shaped to accommodate the curved outer surface of a pumpkin. Stickers may be affixed to each of the facial feature simulation elements to depict details of the facial features. Integrated with the facial feature simulation elements are attachment members, which may be inserted into the crust of the pumpkin. The attachment elements are angled to facilitate proper orientation of the facial feature simulation elements in relation to the outer surface of the pumpkin.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

This disclosure relates to a pumpkin decoration. More particularly, the present disclosure relates to insertable pumpkin decorations mimicking facial features.

2. Description of Related Art

Halloween is a celebration well known in Western countries, and is marked by ghosts, monsters, black magic, vampires, zombies, and other spooky or scary elements. Despite the sinister connotations, it is a festive occasion, with young children going “trick-or-treating,” wherein the children dress up in costumes and trek from house to house asking for candy and other sweets.

Children are not the only ones having fun, however, as adults often decorate their houses and yards with elaborate ornaments consistent with the Halloween theme to greet trick-or-treaters with an impressive presentation. Adults find this activity enjoyable because they are basking in the Halloween atmosphere alongside their children, and feel nostalgic about simpler times as a child when they had no concerns for the struggles and responsibilities of grown-up life, but were only concerned with maximizing the spoils of Halloween night.

One of the most well recognized Halloween decorations is the Jack O'Lantern. Although accounts vary, it is said that there was a clever fellow by the name of Jack who was able to convince the devil not to take his soul upon his death. When Jack died, he was apparently too sinful to enter heaven, but could not enter hell because of his promise with the devil. Jack was thus relegated to roaming the earth looking for a resting place, with only a piece of burning coal as his guide in the dark night. Thereafter, Jack placed the coal in a carved-out turnip, and earned the moniker “Jack of the Lantern,” or simply “Jack O'Lantern.”

In contemporary times, a pumpkin is substituted for the turnip, and varying faces are carved into the surface. The interior of the pumpkin is hollowed out, and a lid is carved out of the top portion to permit insertion and removal of the light source placed within. Openings representative of eyes, a nose, and a mouth are carved out to permit fragments of the light to escape the interior of the pumpkin. The finished Jack O'Lantern is typically placed on windowsills, porches and patios, and front yards.

Unfortunately, carving a Jack O'Lantern may be a dreadful activity for some. In particular, those too caught up in the aforementioned responsibilities of adult life may find it too time-consuming. Still others may consider it a messy process in particular because of the necessity to reach into the pumpkin and manually remove its slimy innards. Additionally, there are individuals lacking dexterity whose efforts may result in a horribly disfigured Jack O'Lantern with the permanent nature of their carving exacerbating this problem. Even worse, carving pumpkins may in extreme cases result in permanent disability from injuries sustained through improper use of carving instruments.

In order to decorate pumpkins without the hassle of carving, a number of insertable decorative devices have been developed. The simplest of such devices are toothpicks having decorative elements attached therearound and which are inserted into the pumpkin. However, these devices may rotate excessively within the pumpkin with the application of a minimal amount of force. Another problem associated with the toothpicks devices is that they re too easily removed.

Another example of a pumpkin decoration device is that which is disclosed in U.S. Pat. No. 6,681,469, issued to Damon (the “Damon reference”), which discloses a graspable pumpkin attachment member integrated with a flexible decorative element. The decorative device of the Damon reference and other similar prior art devices, however, is not understood to be capable of accommodating the various curved surfaces of pumpkins. Furthermore, prior art devices necessitate that the decorator insert the devices from awkward angles in order to provide an aesthetically pleasing appearance of the Jack O'Lantern.

### BRIEF SUMMARY

In light of the forgoing limitations, the present invention was conceived. Provided is a pumpkin decoration device comprising a plurality of facial feature simulation elements, a plurality of facial feature stickers, and one or more angled attachment members. The pumpkin decoration device may be used to decorate a pumpkin (i.e., a Jack O'Lantern).

Each of the facial feature simulation elements may have a curved surface for accommodating the circular face of a pumpkin. Furthermore, each of the facial feature simulation elements is adapted to receive a facial feature sticker which may depict a facial feature such as an eye, a nose, a mouth, etc. Customization of the appearance of the Jack O'Lantern is accomplished through the use of the facial feature stickers.

The facial feature stickers may be configured to mimic the appearance of various Halloween themed creatures. However, the facial feature stickers may be devoid of any imprinted features and blank facial feature stickers may instead be used so that artists can apply or imprint their own individual designs and renderings thereon. The facial feature stickers may be shaped to fit the facial feature simulation elements although the facial feature stickers may have any shape.

The angled attachment members are configured for attaching the facial feature simulation elements to the pumpkin. The angled attachment members may be integrated with each of the facial feature simulation elements to form a unitary structure. In this manner, the facial feature simulation elements may be secured to the pumpkin by inserting the attachment members into the crust of the pumpkin.

### BRIEF DESCRIPTION OF THE DRAWINGS

These and other features and advantages of the various embodiments disclosed herein may be better understood by referring to the following description and drawings in which like numbers refer to like parts throughout and in which:

FIG. 1 is a front view of a pumpkin with a pumpkin decoration device of the present invention attached thereon;

FIG. 2 is a front view of a pumpkin with a preferred embodiment of the pumpkin decoration device including stickers attached thereon;

FIG. 3 is a perspective view of the pumpkin decorating device;

FIG. 4 is a top view of the pumpkin decorating device; and

FIG. 5 is a side view of the pumpkin decorating device.

### DETAILED DESCRIPTION

The detailed description set forth below in connection with the appended drawings is intended as a description of the presently preferred embodiment of the invention, and is not intended to represent the only form in which the present invention may be constructed or utilized. It is to be understood, however, that the same or equivalent functions may be accomplished by different embodiments that are also intended to be encompassed within the spirit and scope of the invention.

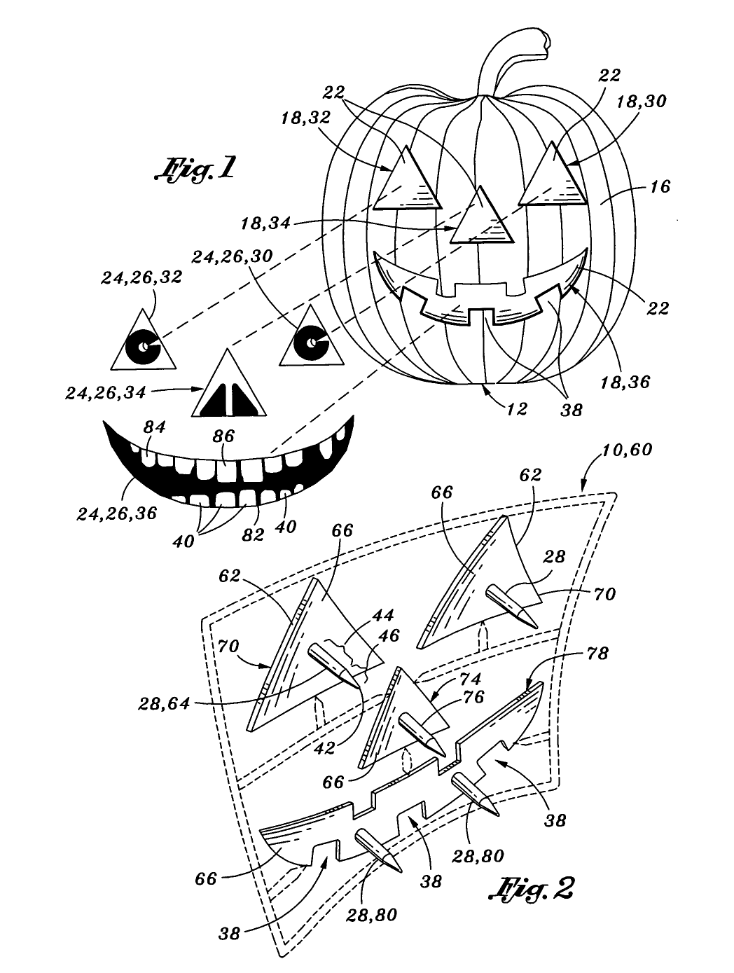

With reference now to FIG. 1, shown is a pumpkin decoration device 10 which, in its broadest sense, comprises a plurality of facial feature simulation elements 18, a plurality of facial feature stickers 24, and a plurality of angled attachment members 28. The pumpkin decoration device 10 may advantageously be used to decorate a pumpkin 12. The facial feature simulation elements 18 may comprise a mouth element 36, a left eye element 30, a right eye element 32, and a nose element 34. The facial feature simulation elements 18 may collectively define the pumpkin decoration device 10 of the present invention.

Although the pumpkin decoration device 10 may serve as decoration for the pumpkin 12 (i.e., Jack O'Lantern), it should be noted that the pumpkin 12 is provided by way of example only and not of limitation. More specifically, it is contemplated that any fruit or vegetable may be used in conjunction with the pumpkin decoration device 10 of the present invention. Preferably, the fruit or vegetable may have a firm yet pierceable outer shell and is preferably a member of the gourd family and may include a squash, melon, or watermelon.

Left and right eye elements 30, 32 are preferably triangularly shaped although the left and right eye elements 30, 32 may be configured in any shape such as circular, square or rectangular. The triangular shape of the left and right eye elements 30, 32 may more realistically depict the traditional shape in which eyes are carved into a Jack O'Lantern. Likewise, the nose element 34 may be shaped similar to the left and right eye elements 30, 32 in that the nose element 34 may be shaped as a triangle. However, the nose element 34 may have a smaller size than that of the left and right eye elements 30, 32 in order to permit its easy identification and to more realistically simulate the appearance of a nose as would appear on a carved Jack O'Lantern. It should be noted that, like the left and right eye elements 30, 32, the nose element 34 may be shaped in any shape other than a triangular shape and, in this regard, the nose element 34 may have a circular shape, a rectangular shape, an oval shape or any other suitable shape.

The mouth element 36 is preferably crescent shaped in order to simulate the appearance of a mouth of an animal. The mouth element 36 may include multiple cut out blocks 38 that simulate the appearance of teeth 40 as would also be depicted on a traditionally carved Jack O'Lantern. However, the mouth element 36 may be configured in any shape other than a crescent shape. In this regard, it is contemplated that the mouth element 36 may have a generally linear shape although the mouth element 36 may be generally rounded in shape or have a skewed or slanted appearance.

The facial feature stickers 24 may be applied to individual ones of the facial feature simulation elements 18 and may include left and right eye stickers 24 that are preferably configured to be attachable to corresponding ones of the left and right eye elements 30, 32. Likewise, a nose sticker 24 is preferably configured to be attachable to the nose element 34 with a mouth sticker 24 being likewise configured to be attachable to the mouth element 36. The size and shape of the left and right eye stickers 24 is preferably configured to be complimentary to the shape of the left and right eye elements 30, 32. In this regard, the size and shape of the left and right eye stickers 24 is preferably the same or substantially the same as that of the left and right eye elements 30, 32. Likewise, the size and shape of the nose sticker 24 is preferably the same or substantially the same as that of the nose element 34. The size and shape of the mouth sticker 24 is such that the mouth sticker 24 is configured to visually block the cut out blocks 38 of the mouth element 36.

Imprinted on each one of the left and right eye stickers 24, nose sticker 24, and mouth sticker 24 may be a thematically consistent rendering of eyes, a nose, and a mouth, respectively. Such renderings may be that of a monster as shown in FIG. 1, or, alternatively, of a skeleton-like appearance, a witch-like appearance, or any other thematic characters associated with any given holiday. However, it should be noted that the left and right eye stickers 24, nose sticker 24 and mouth sticker 24 may be provided with renderings of any article including animal or non-animal articles. In this regard, it should be noted that the imprints on the left and right eye stickers 24, nose sticker 24, and mouth sticker 24 are by way of example only and not of limitation.

Therefore, it is contemplated that the facial feature 26 stickers 24 may be devoid of any imprinted features and blank stickers 24 may instead be used such that unique designs and individual renderings may be applied thereto according to the user's liking. As was earlier mentioned, the facial feature stickers 24 may be shaped to fit respective ones of the facial feature simulation elements 18 although the facial feature stickers 24 may have any shape and any configuration. Furthermore, it is contemplated that the facial feature stickers 24 may not be applied to any of the facial feature simulation elements 18. Alternatively, selective ones of the facial feature stickers 24 may be applied to selective ones of the facial feature simulation elements 18.

It is contemplated that the facial feature stickers 24 may be provided with a layer of adhesive on one side thereof such that the facial feature stickers 24 may be readily adhered or secured to an outer surface 22 of each one of the facial feature simulation elements 18. In this regard, the facial feature stickers 24 may include a self adhesive backing to facilitate attachment to the facial feature simulation elements 18. However, various other means may be utilized to attach the facial feature stickers 24 to the facial feature simulation elements 18. For example, the facial feature stickers 24 may be glued to the facial feature simulation elements 18 or may be attached thereto using adhesive tape, pressure sensitive adhesive, or using a water based adhering process.

Referring now to FIG. 2, shown are mechanisms by which the individual ones of the facial feature simulation elements 18 may be secured to the pumpkin 12. For example, the left eye element 30 may include a left eye element 30 attachment member 28. The right eye element 32 may include a right eye element 32 attachment member 28. Likewise, the nose element 34 may include a nose element 34 attachment member 28 and the mouth element 36 may include a mouth element 36 attachment member. Although only a single one of the attachment members 28 may be connected to a respective one of the facial feature simulation elements 18, it is contemplated that multiple ones of the attachment members 28 may be used in order to secure any individual one of the facial feature simulation elements 18 to the pumpkin 12. Alternatively, although the mouth element 36 is shown in FIG. 2 as having a pair of attachment members 28 for connection to the pumpkin 12, it is contemplated that the mouth element 36 may only have a single one of the attachment members 28 or three or more ones of the attachment members 28 for connecting the mouth element 36 to the pumpkin 12.

Details regarding the attachment member 28 as it relates to the connection of the facial feature 26 attachment member 28 to the pumpkin 12 will now be discussed in the context of the left eye element 30 attachment member 28. It should be noted that the overall configuration of each one of the attachment members is equally applicable to any one of the left and right eye element 30, 32 attachment members 28. Furthermore, the details regarding the configuration of the attachment member 28 may be applied to the nose element 34 attachment member 28 and to the mouth element 34 attachment members. For example, in referring to the details regarding the configuration of the attachment member 28 for the left eye element 30, the attachment member 28 has an attachment end 42. Likewise, the right eye element 32 includes the same configuration of the attachment member 28 as does the nose element 34 and the mouth element 36.

The left eye element 30 attachment member 28 has an attachment end 42 that is integrally formed with a pumpkin 12 insertion end. Furthermore, the left eye element 30 attachment member 28 may be comprised of a shaft portion 44 and a tapered cone section 46 that forms the pumpkin 12 insertion end. The tapered cone section 46 is specifically configured to minimize resistance which may be encountered when piercing the pumpkin 12 crust during installation of the facial feature simulation element 18. Furthermore, the configuration of the shaft portion 44 allows for maximum surface area upon which the pumpkin 12 crust can grip the attachment member 28.

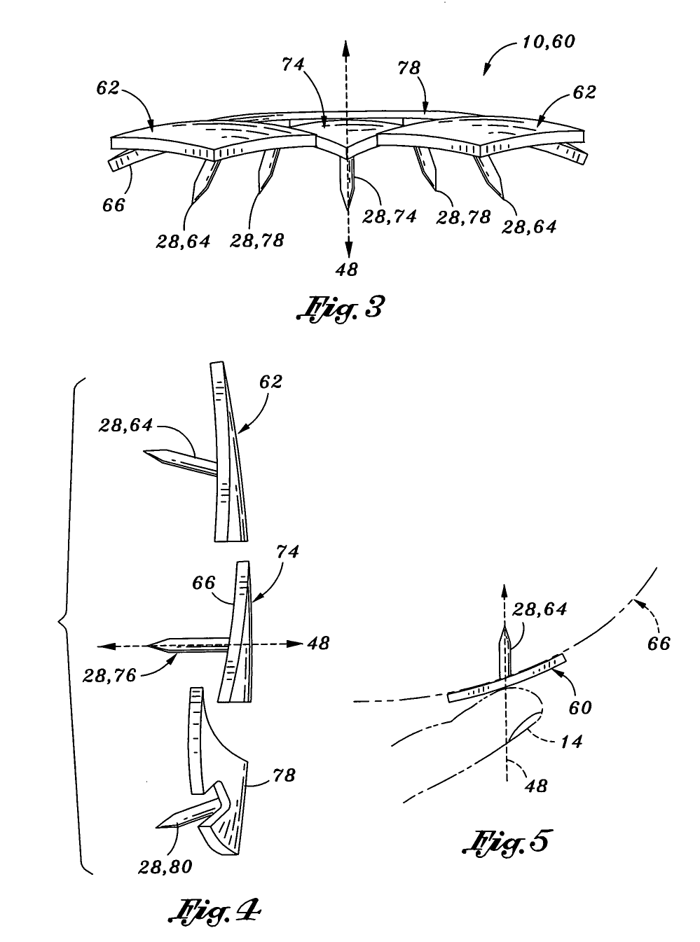

Referring now to FIG. 3, illustrated are each of the attachment members 28 extending from the facial feature simulation elements 18. As can be seen, the left eye element 30 attachment member 28 and the left mouth element 36 attachment member 28 extend outwardly from in a leftwards direction from the facial feature 26 simulation member and form an obtuse angle relative to reference axis 48. Right eye element 32 attachment member 28 and right mouth element 36 attachment member 28 extend laterally outwardly and in a rightwards direction from the facial feature simulation element 18 to form an obtuse angle with respect to the reference axis 48.

Referring now to FIG. 5, shown is a finger of a user 14 of the pumpkin decoration device 10 wherein the user 14 may face the pumpkin 12 along a direction of the reference axis 48 while positioning the left eye element 30 in the desired location on the pumpkin 12 while making angular adjustments thereof to account for the leftward curvature of the pumpkin 12 while simultaneously pushing the left eye element 30 in a direction along the reference axis 48. By configuring the left eye element 30 attachment member 28 to extend outwardly at the obtuse angle in relation to the reference axis 48, installation of the left eye element 30 is simplified from the viewpoint of the user 14 because the direction in which force is applied by the user 14 is the same direction at which the pumpkin 12 decoration will be viewed after installation.

More specifically, by configuring the left eye element 30 attachment member 28 at the obtuse angle, the user 14 merely pushes inwardly in a straight aft direction such that the final position of the facial feature simulation element 18 will be almost identical to the configuration of the facial feature simulation element 18 prior to installation when the user is adjusting the relative positioning of the various ones of the facial feature simulation elements 18 on the pumpkin 12. Referring back to FIG. 3, installation of the right eye element 32 attachment member 28 and right mouth element 36 attachment member 28 is similar due to the orientation thereof with respect to the right eye element 32 and mouth element 36, respectively. As was mentioned above, the specific orientation of the attachment members 28 with respect to the reference axis 48 allows for proper installation of the pumpkin decoration device 10 into the surface of the pumpkin 12.

With reference now to FIG. 4, under the same procedure regarding the configuration and installation of the left eye element 30, the right eye element 32 may likewise be inserted into an upper hemisphere of the pumpkin 12 in a manner that accommodates for the upward curvature of the pumpkin 12. In particular, the left and right eye elements 30, 32 may be placed in the upper hemisphere of the pumpkin 12 while the left and right mouth element 36 attachment members 28 are placed in a lower hemisphere of the pumpkin 12. In this manner, the left and right mouth element 36 attachment members 28 are preferably angled downwardly to form an obtuse angle with reference axis 48 because such left and right mouth element 36 attachment members 28 are inserted into the pumpkin 12 in a manner that accommodates the downward curvature of the pumpkin 12. The nose element 34 attachment member 28 preferably extends parallel to reference axis 48. More specifically, despite the curvature of the nose element 34, the nose attachment member 28 is preferably configured to extend at a normal orientation relative to an inner surface 20 of the nose element 34.

With reference to FIGS. 3 and 4, it can be seen that left and right eye elements 30, 32 each include the inner surfaces 20 having a curvature that is complementary to the curved outer surface 16 of the pumpkin 12. Likewise, the nose element 34 defines an inner surface 20 having a curvature as does the mouth element 36. In order to accommodate pumpkins 12 having varying degrees of curvature of the curved outer surface 16, it is contemplated that left and right eye elements 30, 32, nose element 34 and mouth element 36 are each constructed of a flexible material, such as plastic, such that each may be pressed onto the surface of the pumpkin 12 and flex inwardly or outwardly to accommodate the particular curvature of the curved outer surface 16 of the pumpkin 12. In this regard, it is contemplated that the left and right eye elements 30, 32, nose element 34, and mouth element 36 in combination with the respective ones of the left and right eye element 30, 32 attachment members 28, nose element 34 attachment member 28 and mouth element 36 attachment members 28, respectively, are preferably constructed of a flexible material which may be plastic or metallic material. However, it should be noted that the left and right eye elements 30, 32, nose element 34 and mouth element 36 may be constructed as a unitary structure of any suitable material.

The invention may further be characterized as a decorative pumpkin attachment apparatus 60 which, in its broadest sense, comprises an eye simulating triangular element 62, a nose simulating triangular element 74 and a mouth simulating crescent element 78. The eye simulating triangular element 62 preferably has a curved inner surface 66 for accommodating the curved outer surface 16 of the pumpkin 12. The eye simulating triangular element 62 may further include an integrated eye attachment member 64 for attachment to the pumpkin 12 and which is further adapted to receive a sticker 24 depicting eyes. Likewise, the nose simulating triangular element 74 may include an inner surface 20 for accommodating the curved outer surface 16 of the pumpkin 12. The nose simulating triangular element 74 may include an integrated nose attachment member 76 for attachment to the pumpkin 12 and which is further adapted to receive a sticker 24 depicting a nose.

The mouth simulating crescent element 78 may have a curved inner surface 66 for accommodating the curved outer surface 16 of the pumpkin 12. The mouth simulating crescent element 78 may include at least one integrated mouth attachment member 80 for attachment to the pumpkin 12 and which is further adapted to receive a sticker 24 depicting a mouth. The said eye simulating triangular element 62 may have an interior side 68, an exterior side 70, and a base side 72 with the integrated eye attachment member 64 extending angularly outwardly toward the exterior side 70 and away from the base side 72.

The integrated nose attachment member 76 may extend generally perpendicularly outwardly from the curved inner surface 66 of the nose simulating triangular element 74. The mouth simulating crescent element 78 may define an outer arc 82, an interior arc 84, and a center 86 with the mouth attachment member extending angularly towards the outer arc 82 and away from the center. In this manner, the mouth simulating crescent element 78 may include two or more integrated mouth attachment members 80 that are generally parallel with one another to facilitate installation into the pumpkin 12.

Various embodiments of the present invention is presented to illustrate the preferred embodiments thereof and other inventive concepts may be variously embodied and employed therein. The appended claims are intended to be construed to include such variations except as insofar as limited by the prior art.

1. An insertable pumpkin decoration device comprising:
a. a plurality of facial feature simulation elements, each having a curved surface for accommodating a curved surface of a pumpkin, and being adapted to receive a sticker depicting a facial feature;
b. a plurality of facial feature stickers each being shaped to fit at least one of said facial feature simulation elements; and
c. one or more attachment members integrated with each of said facial feature simulation elements and being configured to be inserted into said pumpkins each of the attachment members forming an oblique angle relative to the curved surface of the respective one of the facial feature simulation elements.

2. The pumpkin decoration device as set forth in claim 1, wherein said facial feature simulation elements are constructed of malleable material enabling said facial feature simulation element to conform to the pumpkin shape.

3. The pumpkin decoration device as set forth in claim 1, wherein said facial feature simulation element is triangularly shaped and depicts an eye.

4. The pumpkin decoration device as set forth in claim 1, wherein said facial feature simulation element is triangularly shaped and depicts a nose.

5. The pumpkin decoration device as set forth in claim 1, wherein said facial feature simulation element is crescent shaped and having an outline that defines a plurality of cut out blocks to depict a mouth with teeth.

6. The pumpkin decoration device as set forth in claim 1, wherein said facial feature stickers are pre-printed with thematically consistent facial features.

7. The pumpkin decoration device as set forth in claim 1, wherein said facial feature stickers are blank and are configured to receive thereon decorative features designed by a user.

8. A decorative pumpkin attachment apparatus comprising:
a. an eye simulating triangular element having a curved inner surface for accommodating an outer surface of a pumpkin, said eye simulating triangular element having an integrated eye attachment member obliquely disposed with respect to the curved inner surface of the eye simulating triangular element for attachment to said pumpkin, and being adapted to receive a sticker depicting eyes;
b. a nose simulating triangular element having a curved inner surface for accommodating the outer surface of said pumpkin, said nose simulating triangular element having an integrated nose attachment member obliquely disposed with respect to the curved inner surface of the nose simulating triangular element for attachment to said pumpkin, and being adapted to receive a sticker depicting a nose; and
c. a mouth simulating crescent element having a curved inner surface for accommodating the outer surface of said pumpkin, said mouth simulating crescent element obliquely disposed with respect to the curved inner surface of the mouth simulating triangular element having at least one integrated mouth attachment member for attachment to said pumpkin, and being adapted to receive a sticker depicting a mouth.

9. The pumpkin attachment apparatus as set forth in claim 8, wherein said eye simulating triangular element has a first triangle side, a second triangle side, and a third triangle side, said eye attachment member extending angularly toward said first triangle side and away from said third triangle side.

10. The pumpkin attachment apparatus as set forth in claim 8, wherein said nose attachment member extends perpendicularly outwardly from the curved inner surface of said nose simulating triangular element.

11. The pumpkin attachment apparatus as set forth in claim 8, wherein said mouth simulating crescent element has an outer arc, an interior arc, and a center, said mouth attachment member extends angularly towards said outer arc and away from said center.
